(19) United States
(12) Patent Application Publication
(10) Pub. No.: US 2007/0105591 A1
(43) Pub. Date: May 10, 2007

(54) Wireless handheld input device

(75) Inventor: Chung-Hung Chan, Taipei (TW)

Correspondence Address: TB05P0109US, P.O. Box 44 - 2049, Taipei, 10668, TW

(73) Assignee: Lifemost Technology Co., Ltd.

(21) Appl. No.: 11/269,536

(22) Filed: Nov. 9, 2005

(51) Int. Cl. H04B 7/00; H04B 1/38

(52) U.S. Cl. 455/557; 455/41.2

(57) ABSTRACT

A wireless handheld input device is provided. The wireless handheld input device includes a microprocessor, a signal transformation module, a wireless transmission/reception module, an audio input module, an audio output module, a keyboard and a pointing touch pad. The electronic modules, the keyboard and the pointing touch pad described above are miniaturized to the handheld size and capable of transmitting wireless control commands. Therefore, the input device of the present invention is used to remotely control an electronic product. The input device of the present invention is further incorporated with an audio input module and an audio output module, which allows the user to input and output audio signals. Therefore, the input device of the present invention is applicable to making network phone calls and using audio input method. Furthermore, the input device of the present invention is incorporated with a receiver of a computer or a terminal, so as to solve the problem of incompatibility between keyboard and mouse, and PDP and LCD-TV.

### BACKGROUND OF THE INVENTION

(1) Field of the Invention

The present invention relates generally to a wireless handheld input device, and more particularly to a wirelessly controlled input device that is capable of making network phone calls and using audio input method.

(2) Description of the Prior Arts

Since the resolution of conventional cathode ray tube (CRT) televisions is too low, the computer generated video signals can not be properly displayed thereon. Therefore, it is difficult to extend the use of internet from the studying room to the living room. It is also the bottleneck for digitizing the living room.

Since the price of plasma display panel (PDP) and liquid crystal display television (LCD-TV) is gradually sliding down, it is for sure that the higher resolution and the larger sized PDP and LCD-TV will replace the traditional CRT television and occupy our living rooms in the near future. One can not only watch TV shows and DVD movies on the larger resolution TV, but use it as a computer monitor. In addition, the Internet accessibility will be extended from the studying room to the living room with the help of wireless broadband network. The user can then browse the web, play computer games, shop online, make phone calls, send and receive e-mails, download video-audio data, and take an online course, all in the living room.

However, it is difficult to use the conventional keyboard and mouse to control a computer or to surf the web, when the user is sitting on a sofa of the living room. Therefore, a new human-machine interface is needed.

For the reasons given above, the conventional devices are insufficient to solve the aforementioned problems, a new device that can solve those problems is thus deemed necessary.

Accordingly, the inventor of the present invention has devoted himself to develop possible solutions for the drawbacks mentioned above. At last, a new wireless handheld input device is developed.

### SUMMARY OF THE INVENTION

One objective of the present invention is to provide a wireless handheld input device that is light in weight and small in size, and can incorporate with a computer. The wireless handheld input device can be operated without spatial restrictions.

Another objective of the present invention is to provide a wireless handheld input device that can input and output audio signals, so as to make network phone calls and use audio input method.

Yet another objective of the present invention is to provide a wireless handheld input device that employs the 900 MHz or 2.4 GHz radio frequency transmission module, which can achieve an operation range of approximately 10 meters.

Still another objective of the present invention is to provide a wireless handheld input device that is easy to use, structurally simple, and has a long life span.

In order to achieve the above and other objectives, the wireless handheld input device of the present invention includes a microprocessor, a signal transformation module, a wireless transmission/reception module, an audio input module, an audio output module, a keyboard and a pointing touch pad. The electronic modules, the keyboard and the pointing touch pad described above are miniaturized to the handheld size and capable of transmitting wireless control commands. Therefore, the input device of the present invention is used to remotely control an electronic product. The input device of the present invention is further incorporated with an audio input module and an audio output module, which allows the user to input and output audio signals. Therefore, the input device of the present invention is applicable to making network phone calls and use audio input method. Furthermore, the input device of the present invention is incorporated with a receiver of a computer or a terminal, so as to solve the problem of incompatibility between keyboard and mouse, and PDP and LCD-TV.

### BRIEF DESCRIPTION OF THE DRAWINGS

FIG. 1 illustrates a block diagram of the wireless handheld input device of the present invention.

FIG. 2A illustrates a front elevation of the wireless handheld input device of the present invention.

FIG. 2B illustrates a left side elevation of the wireless handheld input device of the present invention.

FIG. 2C illustrates a right side elevation of the wireless handheld input device of the present invention.

FIG. 3 illustrates the usage of the wireless handheld input device of the present invention incorporating with a computer and a television display.

FIG. 4 illustrates the usage of the wireless handheld input device of the present invention, which is incorporated with a network phone and an audio input method.

### DETAILED DESCRIPTION OF THE PREFERRED EMBODIMENTS

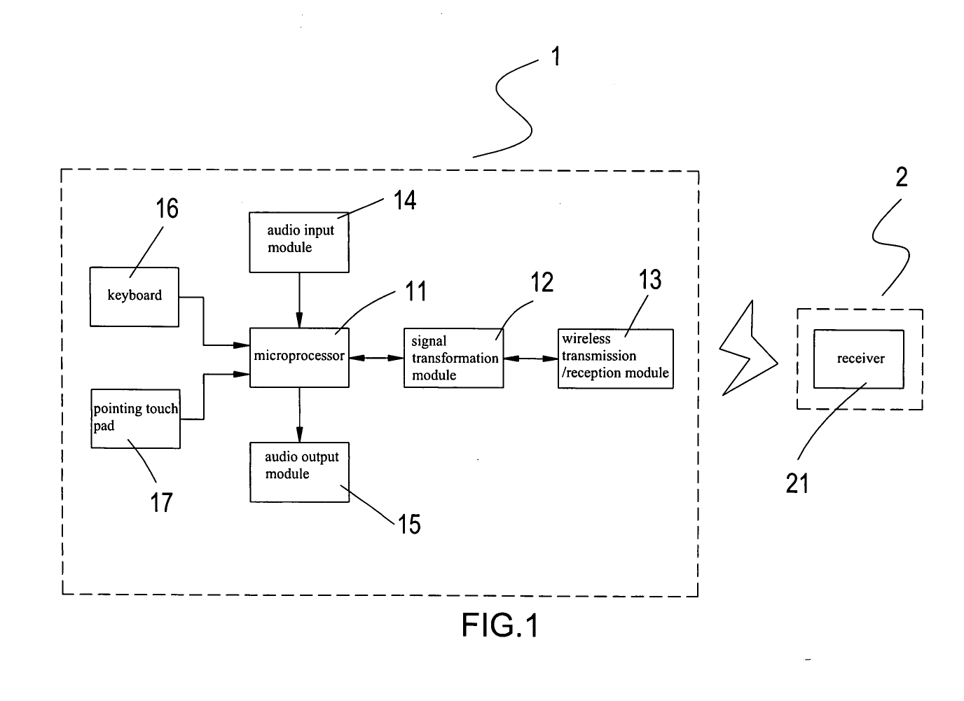

Referring to FIG. 1, a block diagram of a wireless handheld input device of the present invention is illustrated. As shown, the wireless handheld input device of the present invention 1 includes a microprocessor 11, a signal transformation module 12, a wireless transmission/reception module 13, an audio input module 14, an audio output module 15, a keyboard 16 and a pointing touch pad 17.

The microprocessor 11 is connected to the signal transformation module 12, the audio input module 14, the audio output module 15, the keyboard 16 and the pointing touch pad 17. The microprocessor 11 is capable of processing the control signals entered from the audio input module 14, the keyboard 16 and the pointing touch pad 17. After the control signals being completely processed, the results are then sent to the signal transformation module 12.

The signal transformation module 12 receives the control signal sent from the microprocessor 11 and transforms the signals. Then, the transformed signals are sent to the wireless transmission/reception module 13, and input to the microprocessor 11.

The wireless transmission/reception module 13 receives the transformed signals sent from the signal transformation module 12 and wirelessly output the transformed signal to an electronic product 2 that has a receiver 21 via the 900 MHz or the 2.4 GHz radio frequency technology. The electronic product 2 can thus react accordingly. Alternatively, the wireless transmission/reception module 13 can also receive signals sent from the remote electronic product 2, and transfer the received signals to the signal transformation module 12.

The audio input module 14 comprises a microphone for users to input audio signals into the microprocessor 11.

The audio output module 15 comprises a speaker for playing the audio signals sent from the microprocessor 11.

The keyboard 16 is connected to the microprocessor 11, which comprises a plurality of keys for users to input all possible control commands.

The pointing touch pad 17 is connected to the microprocessor 11, which comprises a vector pointing touch pad. The pointing touch pad 17 is often employed in a laptop computer for users to control the movement of a pointer by moving a finger on the surface of the pointing touch pad 17.

In summary, the circuit modules, the keyboard and the pointing touch pad are miniaturized into a wireless handheld device, thereby controlling the electronic product remotely.

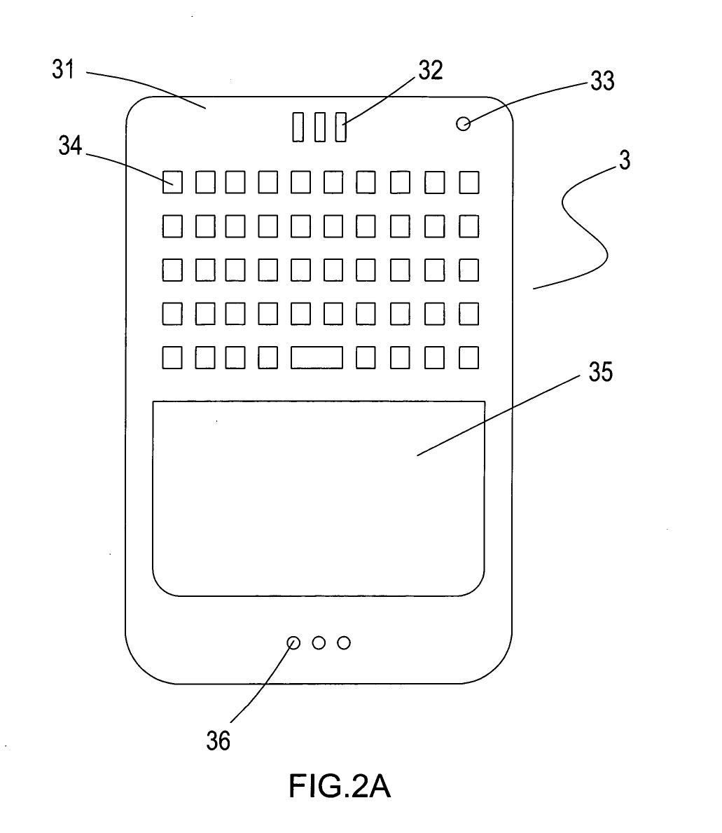

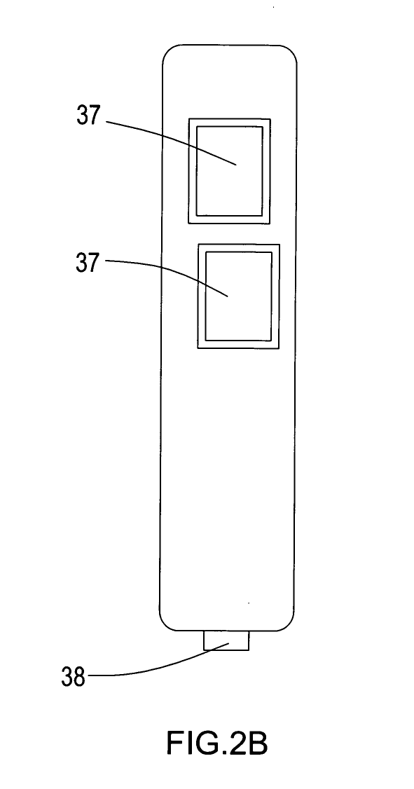

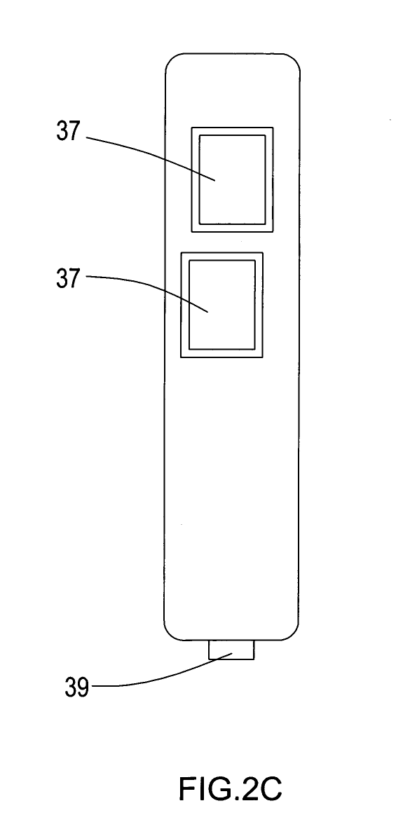

Referring to FIG. 2A, FIG. 2B and FIG. 2C, the front elevation, the left side elevation and the right side elevation of the wireless handheld input device of the present invention are illustrated, respectively. As shown, the front panel 31 of the wireless handheld input device 3 includes a speaker 32 and a power indicator 33, a keyboard 34, a pointing touch pad 35, and a microphone. The left and the right sides of the wireless handheld input device 3 both include a button 37. The bottom portion of the wireless handheld input device 3 includes a microphone connection hole 38 and an earphone connection hole 39. One can see that the wireless handheld input device 3 of the present invention is indeed a miniaturized device and easy to operate.

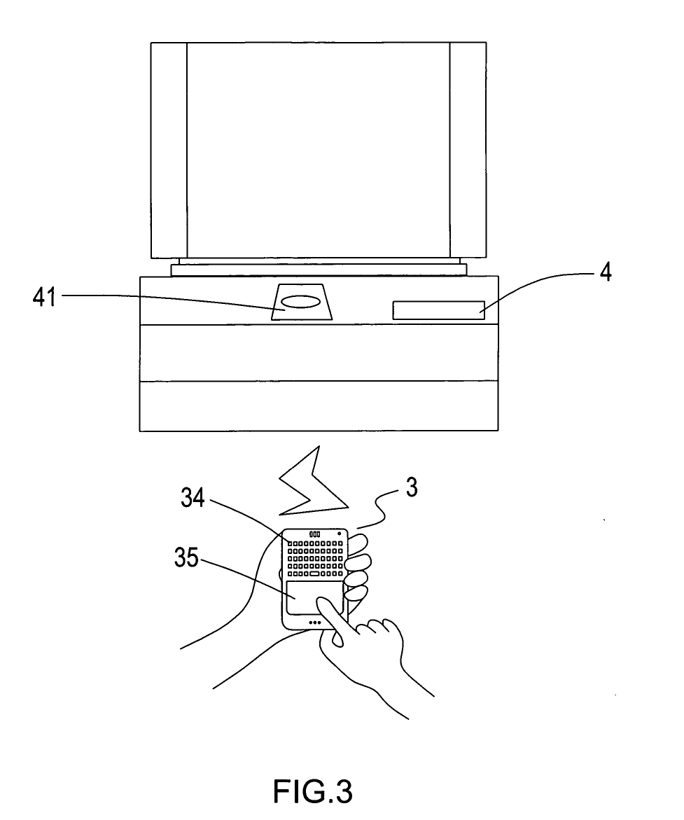

Referring to FIG. 3, the usage of the wireless handheld input device of the present invention, which is incorporated with a computer and a television display, is illustrated. As shown, the wireless handheld input device 3 can be incorporated with the receiver 41 of a computer 4. The user can input data via the keyboard 34 and the pointing touch pad 35, instead of the conventional keyboard and mouse. Thus, the control commands are wirelessly transmitted to the computer without spatial restrictions, and are displayed on the PDP or the LCD-TV monitor. Consequently, the user can easily access a computer 4 while sitting in the living room.

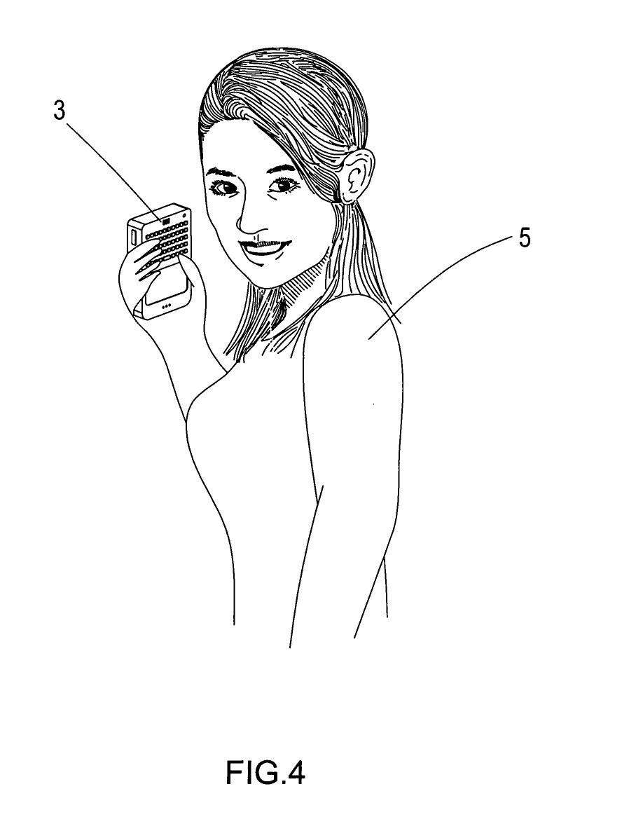

Referring to FIG. 4, the usage of the wireless handheld input device of the present invention, which is incorporated with a network phone and an audio input method, is illustrated. As shown, the user can make a network phone call and input audio signals via the speaker, the microphone and the wirelessly connected network of the wireless handheld input device 3.

In order to further manifest the non-obviousness and the utility of the present invention, a comparison between the wireless handheld input device and the conventional devices is provided in the following.

The Drawbacks of the Conventional Devices:

1. The conventional mouse requires an operation space. It is difficult to operate the conventional mouse at a location with only a restricted operation space.
2. Conventional network phone requires the use of an additional earphone and microphone. Therefore, additional computer accessories are required, which renders the operation inconvenient.
3. The conventional mouse is mostly wired, which has only a limited operation range and requires some assembly.
   The Advantage of the Present Invention:
1. The wireless handheld input device of the present invention is light in weight and small in size, which allows the operation thereof without spatial restrictions.
2. The wireless handheld input device of the present invention includes an input keyboard and a pointing device. In addition, it is easy to use, structurally simple, and has a longer life span.
3. The wireless handheld input device of the present invention employs the 900 MHz or the 2.4 GHz radio frequency transmission module. The operation range can be as far as 10 meters.
4. The wireless handheld input device of the present invention can also input and output audio signals, which is applicable in making network phone calls and using audio input method.

While the invention has been described by means of specific embodiments, numerous modifications and variations could be made thereto by those skilled in the art without departing from the scope and spirit of the invention set forth in the following claims.

In summary, the wireless handheld input device of the present invention can indeed satisfy the patentability requirements of the patent law, a grant of letters patent is thus respectfully requested.

What is claimed is:

1. A wireless handheld input device, comprising a microprocessor, a signal transformation module, a wireless transmission/reception module, an audio input module, an audio output module, a keyboard and a pointing touch pad, wherein:
the microprocessor is connected to the signal transformation module, the audio input module, the audio output module, the keyboard and the pointing touch pad, the microprocessor being capable of processing control signals entered from the audio input module, the keyboard and the pointing touch pad, whereby after the control signals are completely processed, the results are then sent to the signal transformation module;
the signal transformation module receives the control signal sent from the microprocessor and transforms the signals, whereby the transformed signals are sent to the wireless transmission/reception module, and input to the microprocessor;
the wireless transmission/reception module receives the transformed signals sent from the signal transformation module and wirelessly output the transformed signal to an electronic product that has a receiver, thereby controlling the electronic product and receiving the signals sent from the remote electronic product via the wireless transmission/reception module 13 and transferring the received signals to the signal transformation module; whereby
the audio input module is provided for users to input audio signals into the microprocessor, the audio output module is provided for playing the audio signals sent from the microprocessor, the keyboard connected to the microprocessor is provided for users to input all possible control commands, and the pointing touch pad connected to the microprocessor is provided for users to control the movement of a pointer by moving a finger on the surface of the pointing touch pad.

2. The input device as recited in claim 1, wherein the wireless transmission/reception module is operated on the 900 MHz or the 2.4 GHz radio frequency technology.

3. The input device as recited in claim 1, wherein the audio input module comprises a microphone.

4. The input device as recited in claim 1, wherein the audio output module comprises a speaker.
